(19) United States
(12) Patent Application Publication
(10) Pub. No.: US 2013/0133628 A1
(43) Pub. Date: May 30, 2013

(54) LOW ACTUATING FORCE CANISTER PURGE VALVE

(71) Applicant: MAGNETI MARELLI S.P.A., Corbetta (IT)

(72) Inventors: Stefano Fornara, Modena (IT); Marie Lester, West Bloomfield, MI (US); Jeff Becker, Madison Heights, MI (US)

(73) Assignee: MAGNETI MARELLI S.P.A., Corbetta (IT)

(21) Appl. No.: 13/644,189

(22) Filed: Oct. 3, 2012

(30) Foreign Application Priority Data
Oct. 3, 2011 (IT) BO2011A 000563

(51) Int. Cl. F02M 25/08

(52) U.S. Cl. CPC F02M 25/08
USPC 123/516

(57) ABSTRACT

A canister purge valve for an internal-combustion engine is provided with a housing including a supply channel that connects a fuel-vapor inlet port to a fuel-vapor outlet port. A valve scat is disposed across the supply channel. A valve shutter has a pressure-compensating channel and is movably mounted within the supply channel to move from an “open” position, in which the valve shutter is distant from the valve seat, to a “closed” position, in which the valve shutter is pressed against the valve seat. A rigid stem is mechanically coupled to the valve shutter to move the valve shutter from the “open” position to the “closed” position and seals the; pressure-compensating channel in the “closed” position.

This application claims benefit of the filing date of and priority to Italian Patent Application BO2011A 000563 filed on Oct. 3, 2011.

### BACKGROUND OF INVENTION

1. Field of Invention

The invention relates to, in general a canister purge valve and, in particular, a canister-purge solenoid valve (i.e., an electromagnetically actuated canister purge valve) for an internal-combustion engine.

An internal-combustion engine is provided with a canister circuit the function of which is to recover fuel vapors that develop in the fuel tank and introduce such fuel vapors into the cylinders to burn them. This prevents the fuel vapors that develop in the fuel tank from exiting the fuel tank (in particular, when the fuel cap is opened for refueling) and being dispersed freely into the atmosphere.

In a naturally aspirated internal-combustion engine (i.e., without supercharging), the canister circuit comprises a recovery pipe that originates in the fuel tank, ends in the intake-manifold plenum, and is adjusted by a canister-purge solenoid valve of the “ON/OFF” type. Atmospheric pressure is essentially present in the fuel tank whereas a slight vacuum determined by the “aspiration” action generated by the cylinders is present in the intake-manifold plenum. Consequently, when the canister-purge solenoid valve is opened, the gasoline vapors are naturally sucked back along the recovery pipe from the fuel tank into the intake-manifold plenum.

A canister-purge solenoid valve of the “ON/OFF” type comprises a supply pipe, valve seat obtained across the supply pipe, and valve shutter that is movably fitted in the supply pipe to be pushed against the valve seat to achieve a sealing that prevents passage of the fuel vapors. Furthermore, the canister-purge solenoid valve of the “ON/OFF” type comprises a latch spring that presses on the valve shutter to press the valve shutter itself to a “closed” position (i.e., against the valve seat) and an electromagnetic actuator that, when activated, moves the valve shutter from the “closed” position to an “open” position (in which the valve shutter is at a given distance from the valve seat) against the bias of a latch spring.

Recently, internal-combustion-engine manufacturers are asking for a canister-purge solenoid valve that allows to reach high-flow rates even in the presence of minor pressure drops caused by the crossing of the canister-purge solenoid valve itself. To obtain this result, a very large disc-like valve shutter is needed so that the area of the “passage” section that is formed between the disc-like valve shutter and valve seat is large. However, as the size of the disc-like valve shutter increases, there is, consequently, also an increase in the pneumatic three that acts on the disc-like valve shutter and pushes the disc-like valve shutter itself toward the “closed” position due to the pressure difference existing upstream and downstream of the disc-like valve shutter when the disc-like valve shutter is closed. Therefore, as the size of the disc-like valve shutter is increased, also the size (and, therefore, cost and weight) of the electromagnetic actuator must be increased to overcome a pneumatic force that is equally increased.

Patent Application EP0631073A1 describes a canister purge valve for an internal-combustion engine comprising a housing 1 having a supply channel that connects a fuel-vapor inlet port to a fuel-vapor outlet port; a valve seat 3 that is obtained across the supply channel; a valve shutter 13 that is movably fitted in the supply channel to move from an “open” position (shown in FIG. 1c), in which the valve shutter 13 is distant from the valve seat 3 and such that the fuel vapors can flow through a main meatus C2 defined between the valve shutter 13 and valve seat 3, to a “closed” position (shown in FIG. 1a), in which the valve shutter 13 is pressed against the valve seat 3 to seal the supply channel and, therefore, prevent the flow of fuel vapors through the supply channel; and a rigid stem 8 that is mechanically coupled to the valve shutter 13 to move the valve shutter 13 from the “open” position to “closed” position. The valve shutter 13 has a pressure-compensating channel 18 that is sealed by the stem 8 when the stem 8 itself presses the valve shutter 13 against the valve seat 3 in the “closed” position (shown in FIG. 1a). The stem 8, during movement of the valve shatter 13 from the “closed” position (shown in FIG. 1a) to “open” position (shown in FIG. 1c) with respect to the valve seat 3, passes through an “intermediate” position (shown in FIG. 1b) in which the valve shutter 13 is still in contact with the valve seat 3 and, at the same time, the pressure-compensating channel 18 is open and connects two sides of the supply channel that are separated by the valve shutter 13.

It is an object of the invention to make a canister purge valve that is free from the drawbacks of the related art and at the same time, easily and cost-effectively producible.

### SUMMARY

The invention overcomes the drawbacks in the related art in a canister purge valve tor an internal-combustion engine. The canister purge valve comprises a housing including a supply channel that connects a fuel-vapor inlet port to a fuel-vapor outlet port. A valve seat is disposed across the supply channel. A movable valve shutter is assembled within the supply channel and can move from an “open” position, in which the valve shutter is distant from the valve seat such that fuel vapor can flow through a main meatus arranged between the valve shutter and valve seat, and a “closed” position, in which the valve shutter is pressed against the valve seat to seat, the supply channel and prevent the fuel vapor from flowing through the supply channel. A pressure-compensating channel develops along an axial direction and is disposed across the valve shutter. A rigid stem can move with respect to and is mechanically coupled to the valve shutter so that the rigid stem can move the valve shutter from the “open” position, to “closed” position, seals the pressure-compensating channel when the rigid stem presses the valve shutter against the valve seat into the “closed” position, passes through an “intermediate” position, in which the valve shutter is still in contact with the valve seat and the pressure-compensating channel is open and connects two sides of the supply channel that are separated by the valve shutter, during movement of the valve shutter from the “closed” position to “open” position with respect to the valve seat, and is arranged across the pressure-compensating channel. The rigid stem comprises an intermediate portion that is arranged across the pressure-compensating channel and defines an external diameter that is substantially constant and smaller than an internal diameter of the pressure-compensating channel. A buldging portion superiorly delimits the intermediate portion of the rigid stem, is arranged outside the pressure-compensating channel and substantially close to a top opening of the pressure-compensating channel, and defines an external diameter that is larger than the internal diameter of the pressure-compensating channel. A bulging bottom portion interiorly delimits the intermediate portion, is arranged outside the pressure-compensating channel and substantially close to a lower opening of the pressure-compensating channel, and defines an external diameter that is larger than the internal diameter of the pressure-compensating channel.

The canister purge valve is free from the drawbacks of the related art and, at the same time, easily and cost-effectively producible.

Other objects, features, and advantages of the canister purge valve are readily appreciated as the canister purge valve becomes more understood while the subsequent detailed description of at least one embodiment of the canister purge valve is read taken in conjunction with the accompanying drawing thereof.

### BRIEF DESCRIPTION OF EACH FIGURE OF DRAWING

FIG. 1 is a longitudinal diagrammatic view of a canister-purge solenoid valve made according to an embodiment of the invention:

FIGS. 2, 3, and 4 are three respective enlarged scale views of a disc-like valve shutter of the embodiment of the canister-purge solenoid valve shown in FIG. 1 in three different positions; and

FIGS. 5 and 6 are two views from the bottom and top, respectively, of a disc-like valve shutter of the embodiment of the canister-purge solenoid valve shown in FIG. 1.

### DETAILED DESCRIPTION OF EMBODIMENT(S) OF INVENTION

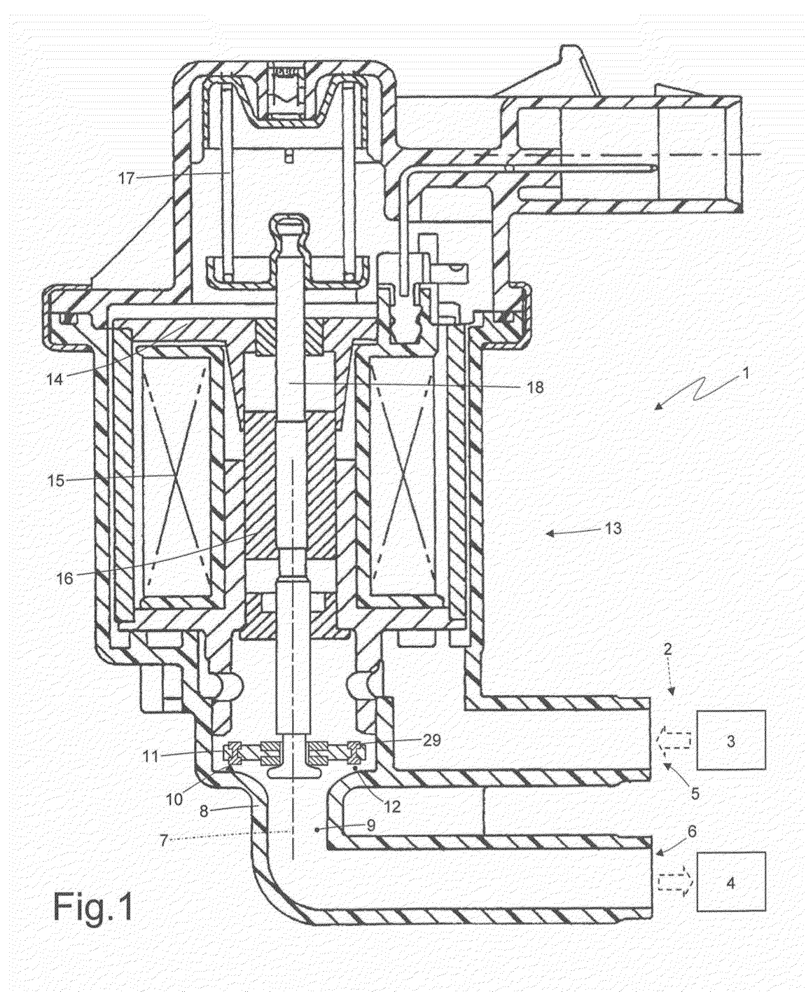

In FIG. 1, a canister-purge solenoid valve for an internal-combustion engine according to an embodiment of the invention is generally indicated at 1. The canister-purge solenoid valve 1 is of the “ON/OFF” type and adapted to be controlled to either allow or prevent passage of fuel vapors through a canister circuit 2 that connects a fuel tank 3 to an intake system 4 of the internal-combustion engine. In particular, an inlet port 5 of the canister-purge solenoid valve 1 communicates with the fuel tank 3 whereas art outlet port 6 of the canister-purge solenoid valve 1 communicates with the intake system 4.

The canister-purge solenoid valve 1 essentially has a cylindrical symmetry about a longitudinal axis 7 and comprises a housing 8, which has a cylindrical-tubular shape with variable section along longitudinal axis 7 and, centrally, a supply channel 9 that connects the inlet port 5 to the outlet port 6 and is crossed in use by the fuel vapors.

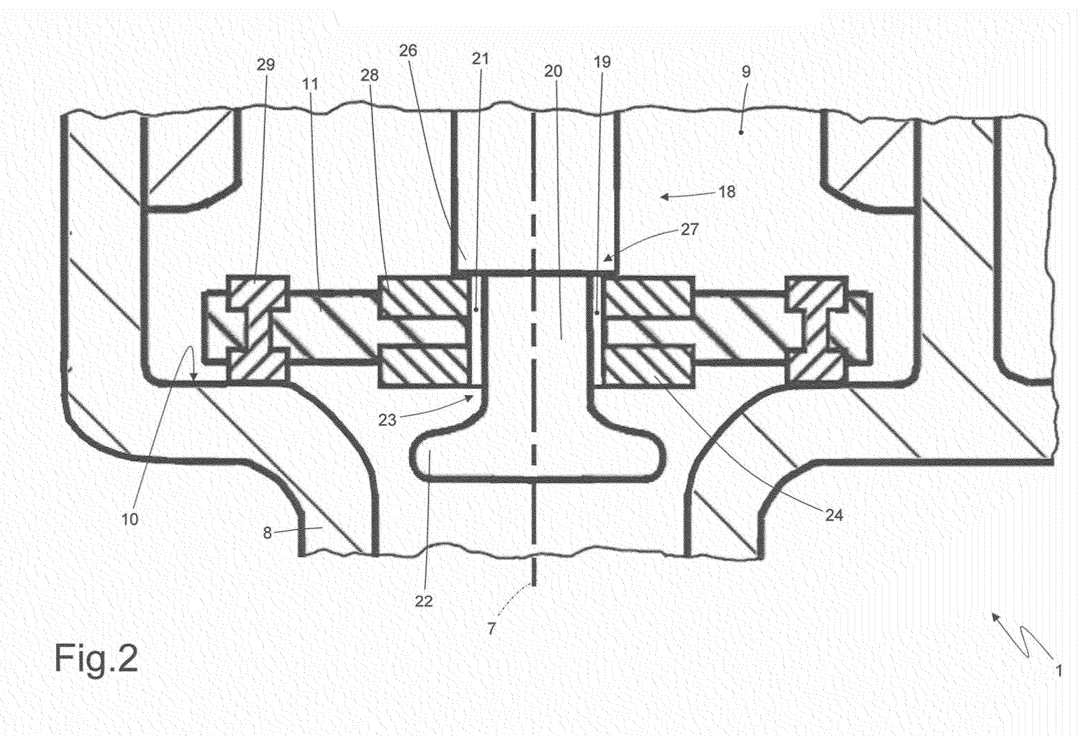

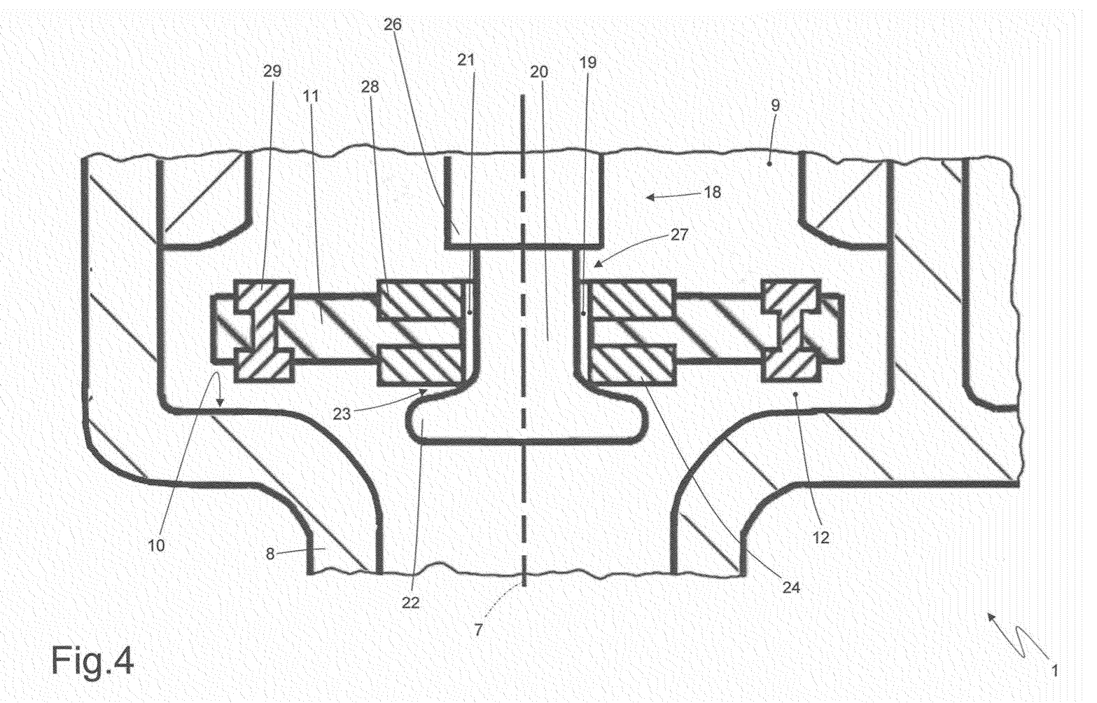

An annular-shaped valve seat 10 is obtained across supply channel 9 and against which a disc-like valve shutter 11 rests to seal the supply channel 9, thus preventing the fuel-vapor flow through, the supply channel 9 itself. In particular, the disc-like valve shutter 11 is movably fitted in the housing 8 to axially move from an “open” position (shown in FIGS. 1 and 4), in which the disc-like valve shutter 11 is axially distant from the valve seat 10 and, thus, the fuel vapors may flow through a main annular meatus 12 defined between the disc-like valve shutter 11 and valve seat 10, to a “closed” position (shown in FIG. 2), in which the disc-like valve shutter 11 is pressed against the valve seat 10 to seal supply channel 9 and, thus, prevent the fuel-vapor flow through the supply channel 9 itself.

An electromagnetic actuator 13 is arranged in the housing 8 and comprises a fixed magnetic armature 14 that is rigidly coupled to the housing 8, a winding 15 that is inserted in the magnetic armature 14, and a mobile keeper 16 that is magnetically coupled to the fixed magnetic armature 14, mechanically integral to the disc-like valve shutter 11, and axially movable to move the disc-like valve shutter 11 from the “open” position (shown in FIGS. 1 and 4) to the “closed” position (shown in FIG. 2). A latch spring 17 that pushes the mobile keeper 16 (and, thus, disc-like valve shutter 11) toward the “closed” position (shown in FIG. 2) acts on the mobile keeper 16 (and, thus, disc-like valve shutter 11 that is mechanically connected to the mobile keeper 16).

The mobile keeper 16 and latch spring 17 are mechanically connected to the disc-like valve shutter 11 by a rigid stem 18 that is developed axially (i.e., parallel to the longitudinal axis 7). In particular, an upper end of the stem 18 is coupled to the latch spring 17, a central portion of the stem 18 is coupled to the mobile keeper 16, and a lower end of the stem 18 is coupled to the disc-like valve shutter 11.

As shown in FIGS. 2 through 4, the disc-like valve shutter 11 has a through-pressure-compensating channel 19 that is arranged axially in “central” position. Therefore, the pressure-compensating channel 19 is arranged in the valve seat 10 (i.e., the annular valve seat 10 is arranged around the pressure-compensating channel 19). The pressure-compensating channel 19 connects the two sides of the supply channel 9 separated by the disc-like valve shutter 11 (in other words, the pressure-compensating channel 19 connects the side upstream of the valve seat 10 to the side downstream of the valve seat 10) by bypassing, in some moments (as is explained in greater detail below), the sealing achieved by the contact between the disc-like valve shutter 11 and valve seat 10 itself.

The stem 18 is arranged through the pressure-compensating channel 19 (i.e., the stem 18 passes through the pressure-compensating channel 19). An intermediate portion 20 of the stem 18 is arranged in the pressure-compensating channel 19 and has an external diameter that is smaller than the internal diameter of the pressure-compensating channel 19 to leave a secondary annular meatus 21 free in the pressure-compensating channel 19 through which the fuel vapors may flow in some moments (as is explained in greater detail below).

The stem 18 has a bulging bottom portion 22 that interiorly delimits the intermediate portion 20, is arranged outside the pressure-compensating channel 19 and close to the lower opening 23 of the pressure-compensating channel 19, and has an external diameter that is larger than the internal diameter of the pressure-compensating channel 19 itself. The disc-shaped valve shutter 11 is provided with a lower annular gasket 24 that is arranged around the lower opening 23 of the pressure-compensating channel 19 and has three ports 25 (i.e., three missing portions as shown in FIG. 6) through which the fuel vapors may pass when the bulging bottom portion 22 of the stem 18 rests on the lower gasket 24 itself. In other words, the lower gasket 24 is shaped to be “permeable” (i.e., so as to not seal when the bulging bottom portion 22 of the stem 18 rests on the lower gasket 24 itself. The function of the lower gasket 24 is, thus, not to achieve a fluid-tight sealing (indeed, by virtue of the ports 25, sealing is completely avoided), but to dampen and attenuate the impact of the bulging bottom portion 22 against the disc-like valve shutter 11 to considerably reduce the mechanical stress and, above all, noise generated by this impact.

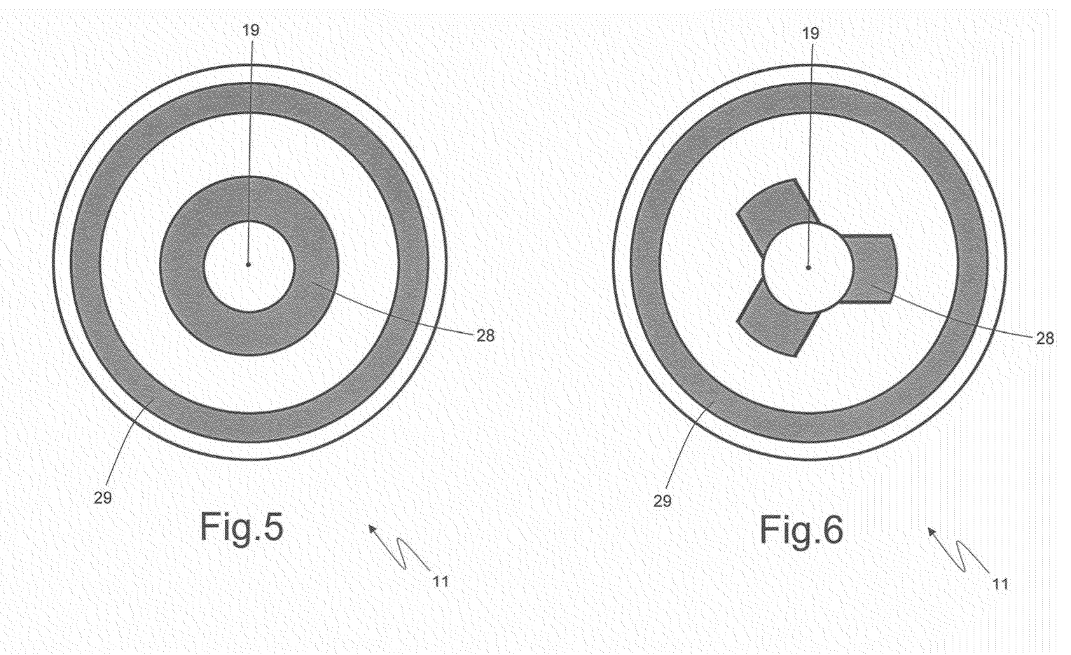

The stem 18 has a bulging top portion 26 that superiorly delimits the intermediate portion 20, is arranged outside the pressure-compensating channel 19 and close to the top opening 27 of the pressure-compensating channel 19, and has an external diameter that is larger than the internal diameter of the pressure-compensating channel 19. The disc-like valve shutter 11 is provided with an annular upper gasket 28 that is arranged around the top opening 27 of the pressure-compensating channel 19 and seals the top opening 27 when the bulging top portion 26 of the stem 18 rests on the upper seal 28 itself. As shown in greater detail in FIG. 5, the upper gasket 28 is seamless (unlike the upper gasket 24, which has the three ports 25) because the main function of the upper gasket 28 is to ensure the sealing of the contact between the bulging top portion 26 of the stem 18 and top opening 27 of the pressure-compensating channel 18.

The stem 18 is not rigidly integral to the disc-like valve shutter 11 and may, thus, perform relative movements with respect to the disc-like valve shutter 11 itself. In other words, the stem 18 is not rigidly restrained to the disc-like valve shutter 11, and, thus, die stem 18 may “reel” with respect to the disc-like valve shutter 11 (or vice versa) within the limits set by the bulging top portion 26 and bulging bottom portion 22 of the stem 18 that constitute “stops”. In other words, the axial dimension of the intermediate portion 20 (i.e., axial distance existing between the bulging top portion 26 of the stem 18 and bulging bottom portion 22 of the stent 18) is greater than the thickness (i.e., axial dimension) of the disc-shaped valve shutter 11. Therefore, the disc-shaped valve shutter 11 is mechanically free to move with respect to the stem 18 within the limits set by the bulging top portion 26 and bulging bottom portion 22 themselves.

According to an embodiment shown in the drawing, the disc-like valve shutter 11 is provided with an external annular gasket 29 that is arranged at the valve seat 10 and rests on the valve seat 10 itself when the valve shutter (11) is in the “closed” position.

In operation of the canister-purge solenoid valve 1 and with particular reference to FIGS. 2, 3 and 4, when the electromagnetic actuator 13 is “off” (i.e., not energized), the latch spring 17 axially pushes the stem 18 downward, and the stem 18 presses the disc-like valve shutter 11 against the valve seat 10, keeping the disc-like valve shutter 11 itself in the “closed” position (shown in FIG. 2). In this position, the bulging top portion 26 in the stem 18 rests against the portion of the disc-like valve shutter 11 that surrounds the top opening 27 of the pressure-compensating channel 19, thus pressing the disc-like valve shutter 11 against the valve seat 10. In this manner (also by virtue of the presence of the external gasket 29 that is fixed to the disc-like valve shutter 11 at the valve seat 10), the disc-like valve shutter 11 seals (i.e., tightly closes) the supply channel 9 and, thus, prevents the flow of fuel vapors through the supply channel 9.

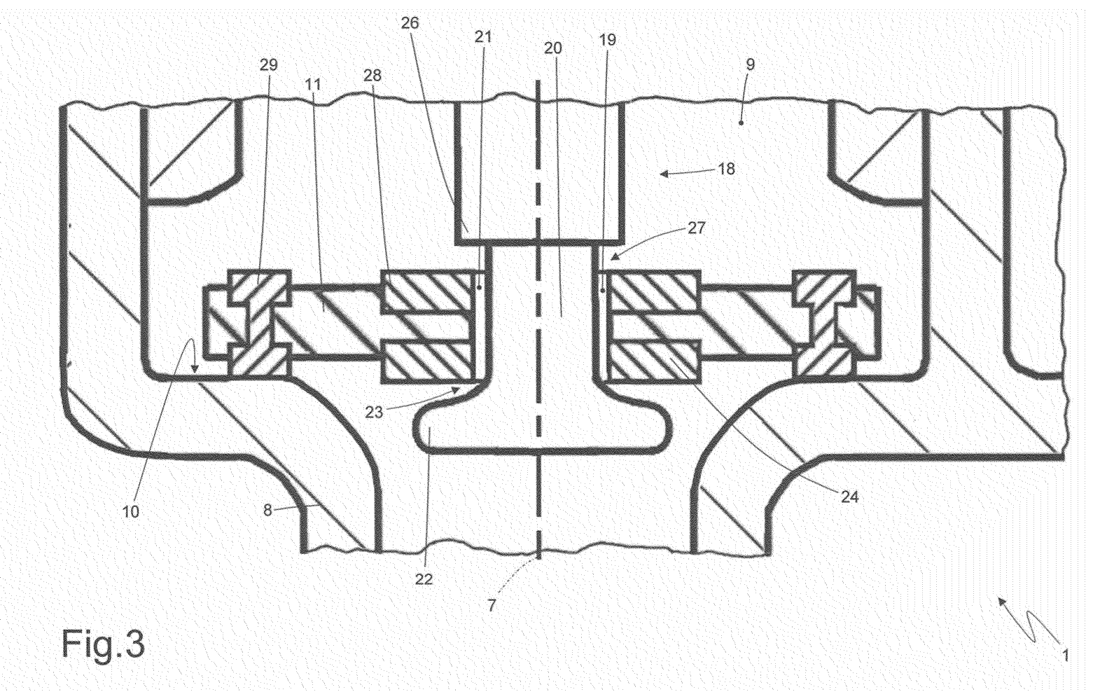

When the electromagnetic actuator 13 is activated (i.e., energized), the magnetic-attraction three generated by the electromagnetic actuator 13 directed upward overcomes the elastic force generated by the latch spring 17 directed downward, and, thus, the stem 18 moves axially upward. As shown In FIG. 3, in the top portion of the upward movement, the stem 18 does not exert any mechanical action on the disc-like valve shutter 11 because, in such a first part of the movement, the bulging top portion 26 of the stem 18 separates from the portion of the disc-like valve shutter 11 that surrounds the top opening 27 of the pressure-compensating channel 19 while the bulging bottom portion 22 of the stem 18 approaches (but still without contact) the portion of the disc-like valve shutter 11 that surrounds the lower opening 23 of the pressure-compensating channel 19. Consequently, the stem 18 is in an “intermediate” position (shown in FIG. 3) in which the disc-like valve shutter 11 is still in contact with the valve seat 10 and both openings 23, 27 of the pressure-compensating channel 19 are (at least partially) free (i.e., not completely sealed by the bulging portions 22, 26 of the stem 18). In this “intermediate” position (shown in FIG. 3), the pressure-compensating channel 19 is open (i.e., fuel vapors may flow through it) and connects the two sides of the supply channel 9 separated by the disc-like valve shutter 11. Therefore, a compensation of the pressure occurs (nearly instantaneously) in this “Intermediate” position (shown in FIG. 3) in the sides of the supply channel 9 separated by the disc-like valve shutter 11 (i.e., the pressures upstream and downstream of the disc-like valve shutter 11 become equal). Thereby, in the “intermediate” position (shown in FIG. 3), the pneumatic force that acts on the disc-like valve shutter 11 and is generated by the pressure difference at the two terminals of the disc-like valve shutter 11 is cancelled out.

Subsequently, the upward, movement of the stem 18 brings the bulging bottom portion 22 into contact with the disc-like valve shutter 11 that surrounds the lower opening 23 of the pressure-compensating channel 19 (i.e., lower gasket 24). Thus, the stem 18 starts pulling the disc-like valve shutter 11 axially upward, thereby moving the disc-like valve shutter 11 toward the “opening” position (shown in FIGS. 1 and 4), wherein the disc-like valve shutter 11 is axially distant from the valve seat 10. Therefore, the fuel vapors may flow through the main annular meatus 12 defined between the disc-like valve shutter 11 and valve seat 10.

The canister-purge solenoid valve 1 has many advantages. Firstly, the canister solenoid valve 1 has a main annular meatus 12 of considerable size (by virtue of a disc-like valve shutter 11 having a large diameter) and, therefore, allows achievement of high flow rates despite the low pressure drops caused by the crossing of the canister-purge solenoid valve 1 itself. Furthermore, the canister-purge solenoid valve 1 allows use of a low-performance electromagnetic actuator 13 (consequently, of small size, low cost, and low weight) because the force applied by the electromagnetic actuator 13 on the disc-like valve shutter 11 (i.e., net of the elastic force generated by the latch spring 17) does not need to overcome a significant pneumatic force. An “upstream”/“downstream” pressure difference of the disc-like valve shutter 11 exists only until the stem 18 reaches the “intermediate” position (shown in FIG. 3), and, in such a part of the movement of the stem 18, the area involved by the movement is very small (a small fraction of the overall area of the disc-like valve shutter 11). Therefore, the generated pneumatic force that must be overcome to move the stem 18 that is generated by the pressure difference upstream/downstream of the disc-like valve shutter 11 is in all cases very small (being proportional to the pressure difference and overall area), When the stem 18 must move the disc-like valve shutter 11 (i.e., after the stem 18 has reached and overcome the “intermediate” position shown in FIG. 3), the pressure difference upstream/downstream of the disc-like valve shutter 11 is zero by effect of the previous opening of the pressure-compensating channel 19, and, therefore, there is no pneumatic force acting on the disc-like valve shutter 11. Finally, the canister-purge solenoid valve 1 is easily and cost-effectively producible in that it does not require any additional actuator or component of complex shape with respect to a similar canister-purge solenoid valve 1 of the known type.

It should be appreciated by those having ordinary skill in the related art that the canister purge valve 1 has been described above in an illustrative manner. It should be so appreciated also that, the terminology that has been used above is intended to be in the nature of words of description rather than of limitation. It should be so appreciated also that many modifications and variations of the canister purge valve 1 are possible in light of the above teachings. It should be so appreciated also that, within the scope of the appended claims, the canister purge valve 1 may be practiced other than as specifically described above.

1. A canister purge valve (1) for an internal-combustion engine, the canister purge valve (1) comprising:
a housing (8) including a supply channel (9) that connects a fuel-vapor-inlet port (5) to a fuel-vapor-outlet port (6);
a valve seat (10) disposed across the supply channel (9);
a movable valve shutter (11) that is assembled within the supply channel (9) and can move from an “open” position, in which the valve shutter (11) is distant from the valve seat (10) such that fuel vapor can flow through a main meatus (12) arranged between the valve shutter (11) and valve seat (10), and a “closed” position, in which the valve shutter (11) is pressed against the valve seat (10) to seal the supply channel (9) and prevent the fuel vapor from flowing through the supply channel (9);
a pressure-compensating channel (19) that develops along an axial direction and is disposed across the valve shutter (11); and
a rigid stem (18) that can move with respect to and is mechanically coupled to the valve shutter (11) so that the rigid stem (18) can move the valve shutter (11) from the “open” position to “closed” position, seals the pressure-compensating channel (19) when the rigid stem (18) presses the valve shutter (11) against the valve seat (10) into the “closed” position, passes through an “intermediate” position, in which the valve shutter (11) is still in contact with the valve seat (10) and the pressure-compensating channel (19) is open and connects two sides of the supply channel (9) that are separated by the valve shutter (11), during movement of the valve shutter (11) from the “closed” position to “open” position with respect to the valve seat (10), and is arranged across the pressure-compensating channel (19), wherein the rigid stem (18) comprises:
an intermediate portion (20) that is arranged across the pressure-compensating channel (19) and defines an external diameter that is substantially constant and smaller than an internal diameter of the pressure-compensating channel (19);
a bulging top portion (26) that superiorly delimits the Intermediate portion (20) of the rigid stem (18), is arranged outside the pressure-compensating channel (19) and substantially close to a top opening (27) of the pressure-compensating channel (19), and defines an external diameter that is larger than the internal diameter of the pressure-compensating channel (19); and
a bulging bottom portion (22) that interiorly delimits the intermediate portion (20), is arranged outside the pressure-compensating channel (19) and substantially close to a lower opening (23) of the pressure-compensating channel (19), and defines an external diameter that is larger than the internal diameter of the pressure-compensating channel (19).

2. A canister purge valve (1) as set forth In claim 1, wherein the valve shutter (11) is provided with an upper gasket (28) that is arranged around the top opening (27) of the pressure-compensating channel (19) and seals the top opening (27) when the bulging top portion (26) of the rigid stem (18) rests on the upper gasket (28).

3. A canister purge valve (1) as set forth in claim 1, wherein the valve shatter (11) is provided with a lower gasket (24) that is arranged around the lower opening (23) of the pressure-compensating channel (19).

4. A canister purge valve (1) as set forth in claim 3, wherein the lower gasket (24) has at least one port (25) through which the fuel vapor can pass when the bulging bottom portion (22) of the rigid stem (18) rests on the lower gasket (24).

5. A canister purge valve (1) as set forth in claim 1, wherein an axial dimension of the intermediate portion (20) is larger than an axial dimension of the valve shutter (11), leaving the valve shutter (11) mechanically free to move with respect to the rigid stem (18).

6. A canister purge valve (1) as set forth in claim 1, wherein the valve seat (10) defines an annular shape and is arranged around the pressure-compensating channel (19).

7. A canister purge valve (1) as set forth in claim 6, wherein the valve shutter (11) is provided with an external gasket (29) that is arranged at the valve seat (10) and rests on the valve seat (10) when the valve shutter (11) is in the “closed” position.

8. A canister purge valve (1) as set forth in claim 1, wherein the valve shutter (11) is shaped as a disc.

9. A canister purge valve (1) as set forth in claim 1, wherein the canister purge valve (1) comprises further an electromagnetic actuator (13) that is mechanically connected to the rigid stem (18) and activated to move the rigid stem (18) from the “closed” position to “open” position.

10. A canister purge valve (1) as set forth in claim 1, wherein the canister purge valve (1) comprises further a latch spring (17) that is mechanically connected to the rigid stem (18) and pushes the rigid stem (18) toward the “closed” position.
